(19) United States
(12) Patent Application Publication
(10) Pub. No.: US 2024/0243935 A1
(43) Pub. Date: Jul. 18, 2024

(54) Adapter Device for Use with Automotive Ethernet and Methods of Use Thereof

(71) Applicant: Argo AI, LLC, Pittsburgh, PA (US)

(72) Inventors: Danson Evan Lu Garcia, Pittsburgh, PA (US); Joshua Smith, Livonia, MI (US)

(21) Appl. No.: 18/154,199

(22) Filed: Jan. 13, 2023

(51) Int. Cl. H04L 12/10; G06F 1/18; G06F 13/38

(52) U.S. Cl. CPC H04L 12/10; G06F 1/189; G06F 13/385; G06F 2213/0042

(57) ABSTRACT

An adapter device for use with automotive Ethernet may include a power connector, a universal serial bus type-c (USB-C) connector, an Ethernet controller, and a power switching circuit, when the power switching circuit is in a first state, the power switching circuit is configured to prevent power from being received from a USB-C device connected via the USB-C connector, when the power switching circuit is in a second state, the power switching circuit is configured to allow power to be received from a USB-C device connected via the USB-C connector, and the Ethernet controller is configured to convert a first signal received via the USB-C connector to a second signal that is formatted for automotive Ethernet. Methods, computer program products, and autonomous vehicles are also disclosed.

### BACKGROUND

### 1. Field

This disclosure relates generally to aspects of devices for use with automotive Ethernet and, in some non-limiting embodiments, to an adaptor that is configured to translate data from a universal serial bus type-c (USB-C) device into automotive Ethernet data and vice versa, and to provide power to a USB-C device.

### 2. Technical Considerations

An autonomous vehicle (AV) (e.g., a driverless car, a driverless auto, a self-driving car, a robotic car, etc.) is a vehicle that is capable of sensing an environment of the vehicle and traveling (e.g., navigating, moving, etc.) in the environment without manual input from an individual. An AV uses a variety of techniques to detect the environment of the AV, such as radar, laser light, Global Positioning System (GPS), odometry, and/or computer vision. In some instances, an AV uses a control system to interpret information received from one or more sensors, to identify a route for traveling, to identify an obstacle in a route, and to identify relevant traffic signs associated with a route.

Automotive Ethernet may refer to a form of an Ethernet network that includes a physical layer specifically adapted for automotive use cases. An Automotive Ethernet protocol may include the use of a physical layer device to connect components within an AV using a wired network. Automotive Ethernet may be designed to meet the needs of the automotive market, including electrical requirements (e.g., emissions from and/or susceptibility to electromagnetic interference (EMI), including radio frequency interference (RFI)), bandwidth requirements, latency requirements, synchronization, and/or network management requirements.

### SUMMARY

Provided are systems, methods, products, apparatuses, and/or devices for operation of an automotive Ethernet adaptor device.

According to some non-limiting embodiments, provided is an adapter device for use with automotive Ethernet, the adapter device comprising: a power connector; a universal serial bus type-c (USB-C) connector; and a power switching circuit; wherein, when the power switching circuit is in a first state, the power switching circuit is configured to prevent power from being received from a USB-C device connected via the USB-C connector; and wherein, when the power switching circuit is in a second state, the power switching circuit is configured to allow power to be received from the USB-C device connected via the USB-C connector.

According to some non-limiting embodiments, provided is an adapter device for use with automotive Ethernet, the adapter device comprising: a power connector; a universal serial bus type-c (USB-C) connector; an Ethernet controller; and a power switching circuit; wherein, when the power switching circuit is in a first state, the power switching circuit is configured to prevent power from being received from a USB-C device connected via the USB-C connector; wherein, when the power switching circuit is in a second state, the power switching circuit is configured to allow power to be received from the USB-C device connected via the USB-C connector; and wherein the Ethernet controller is configured to convert a first signal received via the USB-C connector to a second signal that is formatted for automotive Ethernet.

According to some non-limiting embodiments, provided is vehicle method for operating an adapter device for use with automotive Ethernet, the method comprising: determining, with at least one processor, whether a power source is connected to a power connector of an adapter device; determining, with at least one processor, whether a power switching circuit is in a first state based on determining that a power source is not connected to the power connector of the adapter device, wherein, when the power switching circuit is in the first state, the power switching circuit is configured to prevent power from being received from a universal serial bus type-c (USB-C) device connected via a USB-C connector of the adapter device; determining, with at least one processor, whether the power switching circuit is in a second state based on determining that the power switching circuit is not in the second state, wherein, when the power switching circuit is in the second state, the power switching circuit is configured to allow power to be received from the USB-C device connected via the USB-C connector and allowing, with at least one processor, power to be received from the USB-C device connected via the USB-C connector based on determining that the power switching circuit is in the second state.

### BRIEF DESCRIPTION OF THE DRAWINGS

Additional advantages and details are explained in greater detail below with reference to the exemplary embodiments that are illustrated in the accompanying schematic figures, in which:

FIG. 1 is a diagram of a non-limiting embodiment of an environment in which systems, methods, and/or computer program products, described herein, may be implemented;

FIG. 2 is a diagram of a non-limiting embodiment of an architecture for an autonomous vehicle (AV);

FIG. 3 is a diagram of a non-limiting embodiment of an architecture for a light detection and ranging (LiDAR) system;

FIG. 4 is a diagram of a non-limiting embodiment of a computing device;

FIG. 5 is a diagram of a non-limiting embodiment of an automotive Ethernet adaptor device;

FIG. 6 is a diagram of a non-limiting embodiment of power architecture of an automotive Ethernet adaptor device;

FIG. 7 is a diagram of a non-limiting embodiment of power switching circuit of an automotive Ethernet adaptor device;

FIG. 8 is a perspective view of a non-limiting embodiment of an automotive

Ethernet adaptor device;

FIG. 9 is a diagram of a non-limiting embodiment of an AV with an automotive Ethernet adaptor device installed; and

FIG. 10 is a flowchart of a non-limiting embodiment of a process for operating an automotive Ethernet adaptor device for use with automotive Ethernet.

### DESCRIPTION

It is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments. Hence, specific dimensions and other physical aspects related to the embodiments disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” As used in the specification and the claims, the singular form of “a,” “an,” and “the” include plural referents, such as unless the context clearly dictates otherwise. Additionally, as used herein, the terms “set” and “group” are intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. Further, the phrase “based on” is intended to mean “based at least partially on” unless explicitly stated otherwise. Further, the phrase “based on” may mean “in response to” and be indicative of a condition for automatically triggering a specified operation of an electronic device (e.g., a processor, a computing device, etc.) as appropriately referred to herein.

As used herein, the term “communication” may refer to the reception, receipt, transmission, transfer, provision, and/or the like, of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

It will be apparent that systems and/or methods, described herein, can be implemented in different forms of hardware, software, or a combination of hardware and software. The actual specialized control hardware or software code used to implement these systems and/or methods is not limiting of the implementations. Thus, the operation and behavior of the systems and/or methods are described herein without reference to specific software code, it being understood that software and hardware can be designed to implement the systems and/or methods based on the description herein.

Some non-limiting embodiments are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

The term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, aircraft, aerial drones, and the like. An “autonomous vehicle” is a vehicle having a processor, programming instructions, and drivetrain components that are controllable by the processor without requiring a human operator. An autonomous vehicle may be fully autonomous in that the autonomous vehicle does not require a human operator for most or all driving conditions and functions. In some non-limiting embodiments, the autonomous vehicle may be semi-autonomous in that a human operator may be required in certain conditions or for certain operations, or that a human operator may override the vehicle's autonomous system and may take control of the vehicle.

As used herein, the term “computing device” may refer to one or more electronic devices configured to process data. A computing device may in some examples, include the necessary components to receive, process, and output data, such as a processor, a display, a memory, an input device, a network interface, and/or the like. In some non-limiting embodiments, a computing device may be a mobile device. As an example, a mobile device may include a cellular phone (e.g., a smartphone or standard cellular phone), a portable computer (e.g., a tablet), a wearable device (e.g., watches, glasses, lenses, clothing, and/or the like), a personal digital assistant (PDA), and/or other like devices. In some non-limiting embodiments, a computing device may be a computer that is not portable (e.g., is not a mobile device), such as a desktop computer (e.g., a personal computer).

As used herein, the term “server” and/or “processor” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, mobile devices, desktop computers, etc.) directly or indirectly communicating in the network environment may constitute a “system.” Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “user interface” or “graphical user interface” may refer to a display generated by a computing device, with which a user may interact, either directly or indirectly (e.g., through a keyboard, mouse, touchscreen, etc.).

In some non-limiting embodiments, a vehicle, such as an autonomous vehicle may include a media converter device that is used to convert an automotive Ethernet signal (e.g., a signal having a 100/1000BASE-T1 format) to or from a local area network (LAN) Ethernet signal (100/1000BASE-TX) via an Ethernet connector (e.g., an RJ45 connector). In some non-limiting embodiments, the media convertor may include a universal serial bus type-c (USB-C) connector, however, the media converter device may not include the components necessary to provide for media communications from a USB-C device to vehicle components over automotive Ethernet.

In addition, the media converter device may receive power via a power signal provided at the Ethernet connector. Accordingly, in a situation where a USB-C device is connected to media converter device via the Ethernet connector, the USB-C device may end up providing power to media converter device and, thus, depletes a power source of the USB-C. This dependency on the USB-C device may cause issues when the USB-C device is connected to the media converter device over a period of time (e.g., overnight). In such situations, the USB-C device may lose power even when the media converter device is not required to operate.

The present disclosure provides systems, methods, and computer program products that involves the use of an automotive Ethernet adaptor device. In some non-limiting embodiments, an automotive Ethernet adaptor device is disclosed that includes a power connector, a USB-C connector, and a power switching circuit, wherein, when the power switching circuit is in a first state, the power switching circuit is configured to prevent power from being received from a USB-C device connected via the USB-C connector, and wherein, when the power switching circuit is in a second state, the power switching circuit is configured to allow power to be received from a USB-C device connected via the USB-C connector.

In some non-limiting embodiments, when a power source is connected to the power connector, the power switching circuit is configured to allow power to be provided to a USB-C device connected via the USB-C connector. In some non-limiting embodiments, the automotive Ethernet adaptor device may include a printed circuit board (PCB), and the power connector, the USB-C connector, and the power switching circuit may be attached to the PCB. In some non-limiting embodiments, the power switching circuit may include a USB Power Delivery (PD) device that is configured to provide power at the USB-C connector.

In some non-limiting embodiments, the automotive Ethernet adaptor device may further include a DC-DC convertor connected to the power connector, wherein the DC-DC convertor is configured to provide a power signal to the power switching circuit. In some non-limiting embodiments, the automotive Ethernet adaptor device may further include an Ethernet controller, and a PCB, and the power connector, the USB-C connector, the power switching circuit, and the Ethernet controller may be attached to the PCB, and the Ethernet controller is configured to convert a first signal received from a USB-C device via the USB-C connector to a second signal that is formatted for automotive Ethernet. In some non-limiting embodiments, the automotive Ethernet adaptor device may further include an Ethernet connector, and the power connector, the USB-C connector, the power switching circuit, the Ethernet controller, and the Ethernet connector are attached to the PCB.

In some non-limiting embodiments, an automotive Ethernet adaptor device may include a power connector, a USB-C connector, an Ethernet controller, and a power switching circuit, when the power switching circuit is in a first state, the power switching circuit is configured to prevent power from being received from a USB-C device connected via the USB-C connector, and, when the power switching circuit is in a second state, the power switching circuit is configured to allow power to be received from a USB-C device connected via the USB-C connector, and the Ethernet controller is configured to convert a first signal received via the USB-C connector to a second signal that is formatted for automotive Ethernet. In some non-limiting embodiments, the first signal is a signal formatted according to a USB 3.0 standard, the second signal is a signal formatted for Local Area Network (LAN) Ethernet, and the Ethernet controller is configured to convert the signal formatted according to a USB 3.0 standard received via the USB-C connector to the signal that is formatted according to a 100BASE-T1 Ethernet standard.

In some non-limiting embodiments, the automotive Ethernet adaptor device may further include an Ethernet connector and an Ethernet physical layer device, and the Ethernet physical layer device is configured to receive the second signal from the Ethernet controller and convert the second signal to a third signal that is formatted for automotive Ethernet, and the Ethernet physical layer device is configured to provide the third signal to a device connected at the Ethernet connector. In some non-limiting embodiments, the Ethernet physical layer device is configured to convert the second signal to a 100/1000BASE-T1 format. In some non-limiting embodiments, the automotive Ethernet adaptor device may further include a DC-DC convertor connected to the power connector, wherein the DC-DC convertor is configured to provide a power signal to the power switching circuit. In some non-limiting embodiments, the power switching circuit may include a PD device that is configured to provide power at the USB-C connector. In some non-limiting embodiments, the automotive Ethernet adaptor device may further include a hotswap controller device, and the hotswap controller device is configured to provide a control signal to the power switching circuit to cause the power switching circuit to change to the second state.

In some non-limiting embodiments, an AV may include an automotive Ethernet adapter device that may include a power connector, a USB-C connector, an Ethernet connector, an Ethernet physical layer device, an Ethernet controller, and a power switching circuit, and, when the power switching circuit is in a first state, the power switching circuit is configured to prevent power from being received from a USB-C device connected via the USB-C connector, and, when the power switching circuit is in a second state, the power switching circuit is configured to allow power to be received from a USB-C device connected via the USB-C connector, and the Ethernet controller is configured to convert a first signal received via the USB-C connector to a second signal that is formatted for automotive Ethernet, and the Ethernet physical layer device is configured to receive the second signal from the Ethernet controller and convert the second signal to a third signal that is formatted for automotive Ethernet, and the Ethernet physical layer device is configured to provide the third signal to a device connected at the Ethernet connector. In some non-limiting embodiments, the first signal is a signal formatted according to a USB 3.0 standard, wherein the second signal is a signal formatted according to a 100BASE-T1 Ethernet standard, and wherein the Ethernet controller is configured to convert the signal formatted according to a USB 3.0 standard received via the USB-C connector to the signal that is formatted according to the 100BASE-T1 Ethernet standard. In some non-limiting embodiments, the Ethernet physical layer device is configured to convert the second signal to a 100/1000BASE-T1 format. In some non-limiting embodiments, the automotive Ethernet adaptor device may include a DC-DC convertor connected to the power connector, wherein the DC-DC convertor is configured to provide a power signal to the power switching circuit. In some non-limiting embodiments, the power switching circuit may include a USB PD device that is configured to provide power at the USB-C connector. In some non-limiting embodiments, the automotive Ethernet adaptor device may further include a hotswap controller device, and the hotswap controller device is configured to provide a control signal to the power switching circuit to cause the power switching circuit to change to the second state.

In some non-limiting embodiments, a method of operating an adapter device for use with automotive Ethernet comprises determining whether a power source is connected to a power connector of an adapter device, determining whether a power switching circuit is in a first state based on determining that a power source is not connected to the power connector of the adapter device, wherein, when the power switching circuit is in the first state, the power switching circuit is configured to prevent power from being received from a USB-C device connected via a USB-C connector of the adapter device, and determining whether the power switching circuit is in a second state based on determining that the power switching circuit is not in the second state, wherein, when the power switching circuit is in the second state, the power switching circuit is configured to allow power to be received from a USB-C device connected via the USB-C connector, and allowing power to be received from a USB-C device connected via the USB-C connector based on determining that the power switching circuit is in the second state.

In some non-limiting embodiments, the method further comprises converting, via an Ethernet controller, a first signal received via the USB-C connector to a second signal that is formatted for automotive Ethernet, wherein the first signal is a signal formatted according to a USB 3.0 standard, and wherein the second signal is a signal formatted according to a 100BASE-T1 Ethernet standard. In some non-limiting embodiments, the second signal may be a signal formatted for LAN Ethernet. In some non-limiting embodiments, converting the first signal received via the USB-C connector to the second signal that is formatted for automotive Ethernet comprises converting the signal formatted according to a USB 3.0 standard and received via the USB-C connector, to the signal that is formatted according to the 100BASE-T1 Ethernet standard. In some non-limiting embodiments, the method further comprises receiving, via an Ethernet physical layer device, the second signal from the Ethernet controller, converting the second signal to a third signal that is formatted for automotive Ethernet, and providing, via the Ethernet physical layer device, the third signal to a device connected at an Ethernet connector.

In some non-limiting embodiments, the method further comprises providing a control signal, via a hotswap controller, to the power switching circuit to cause the power switching circuit to change from the first state to the second state. In some non-limiting embodiments, the method further comprises providing power, via a USB PD device, at the USB-C connector.

In this way, the automotive Ethernet adaptor device of the present disclosure eliminates the need for using multiple separate components to provide power to a USB-C device and to provide for conversion between data from a USB-C device and an automotive Ethernet network, such as an automotive Ethernet network of an AV. Furthermore, in a situation where a USB-C device is connected to the automotive Ethernet adaptor device, the USB-C device may be prevented from providing power to devices that may otherwise deplete a power source of the USB-C and the automotive Ethernet adaptor device may prevent the USB-C device from losing power when the automotive Ethernet adaptor device is not required to operate.

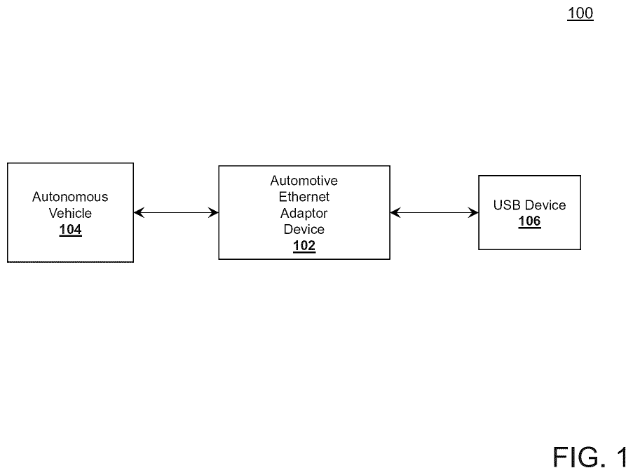

Referring now to FIG. 1, FIG. 1 is a diagram of an example environment 100 in which systems, methods, products, apparatuses, and/or devices described herein, may be implemented. As shown in FIG. 1, environment 100 may include automotive Ethernet adaptor device 102, autonomous vehicle 104, and USB device 106. The devices of FIG. 1 may be connected by wired and/or wireless connections as appropriate.

Automotive Ethernet adaptor device 102 may include one or more devices and/or components capable of facilitating communication between autonomous vehicle 104 and USB device 106. For example, automotive Ethernet adaptor device 102 may include an Ethernet connector, an Ethernet Physical Layer device, an Ethernet controller, and/or a USB-C connector. In some non-limiting embodiments, automotive Ethernet adaptor device 102 may include a single module adapter that translates data from a USB format, such as USB 3.0 data, into data in automotive Ethernet format and provides USB power delivery, for example to USB device 106 via a USB-C connector.

Autonomous vehicle 104 may include one or more devices capable of communicating with USB device 106 via automotive Ethernet adaptor device 102. For example, autonomous vehicle 104 may include a computing device, such as a server, a group of servers, and/or other like devices. In some non-limiting embodiments, automotive Ethernet adaptor device 102 may be a component of autonomous vehicle 104. In some non-limiting embodiments, USB device 106 may be a component of autonomous vehicle 104.

USB device 106 may include one or more devices capable of communicating with autonomous vehicle 104 via automotive Ethernet adaptor device 102. For example, USB device 106 may include a computing device, such as a mobile device (e.g., a tablet, a smartphone, a laptop computer, etc.), a desktop computer, and/or other like devices, which may communicate data in a USB format, such as a signal formatted according to a USB standard, such as USB 3.0, 3.1, and/or the like. In some examples, USB device 106 may include one or more USB-A devices, one or more USB-C devices, one or more Micro USB devices, and/or the like. Additionally or alternatively, USB device 106 may include a USB connector, such as a USB-C connector. In some non-limiting embodiments, USB device 106 may include automotive Ethernet adaptor device 102. For example, automotive Ethernet adaptor device 102 may be a component of USB device 106. In some non-limiting embodiments, USB device 106 may be a component of autonomous vehicle 104.

In some non-limiting embodiments, data may be received by and/or transmitted to autonomous vehicle 104 and/or USB device 106 via a communication network, which may include one or more wired and/or wireless networks. In some examples, the communication network may include a cellular network (e.g., a long-term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of devices and systems shown in FIG. 1 is provided as an example. There may be additional devices and/or systems, fewer devices and/or systems, different devices and/or systems, or differently arranged devices and/or systems than those shown in FIG. 1. Furthermore, two or more devices and/or systems shown in FIG. 1 may be implemented within a single device and/or system, or a single device and/or system shown in FIG. 1 may be implemented as multiple, distributed devices and/or systems. In some non-limiting embodiments, autonomous vehicle 104 may incorporate the functionality of automotive Ethernet adaptor device 102, such that autonomous vehicle 104 can operate without automotive Ethernet adaptor device 102 (e.g., without communication to or from automotive Ethernet adaptor device 102). Additionally or alternatively, a set of devices and/or systems (e.g., one or more devices or systems) of environment 100 may perform one or more functions described as being performed by another set of devices and/or systems of environment 100.

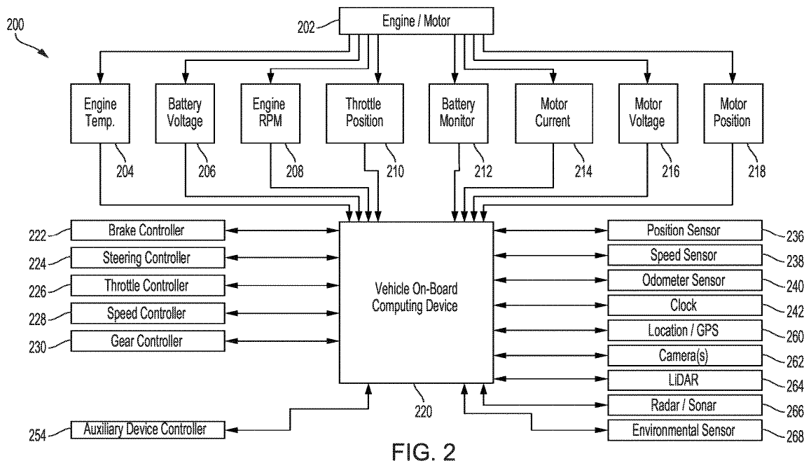

Referring now to FIG. 2, FIG. 2 is an illustration of a non-limiting embodiment of system architecture 200 for a vehicle, such as an autonomous vehicle. An autonomous vehicle may include a same or similar system architecture as that of system architecture 200 shown in FIG. 2. As shown in FIG. 2, system architecture 200 may include engine or motor 202 and various sensors 204-218 for measuring various parameters (e.g., characteristics) of the vehicle. In gas-powered or hybrid vehicles having a fuel-powered engine, the sensors may include, for example, engine temperature sensor 204, battery voltage sensor 206, engine rotations per minute (RPM) sensor 208, throttle position sensor 210, and/or a seat occupancy sensor (not shown). In an electric or hybrid vehicle, the vehicle may have an electric motor and may have sensors, such as battery monitor sensor 212 (e.g., to measure current, voltage, and/or temperature of the battery), motor current sensor 214, motor voltage sensor 216, and/or motor position sensor 218, such as resolvers and encoders.

System architecture 200 may include operational parameter sensors, which may be common to both types of vehicles and may include, for example: position sensor 236, such as an accelerometer, gyroscope, and/or inertial measurement unit; speed sensor 238; and/or odometer sensor 240. System architecture 200 may include clock 242 that is used to determine vehicle time during operation. Clock 242 may be encoded into vehicle on-board computing device 220. It may be a separate device or multiple clocks may be available.

System architecture 200 may include various sensors that operate to gather information about an environment in which the vehicle is operating and/or traveling. These sensors may include, for example: location sensor 260 (e.g., a global positioning system (GPS) device); object detection sensors, such as one or more camera(s) 262; LiDAR sensor system 264; and/or radar and/or sonar system 266. The sensors may include environmental sensor 268, such as a precipitation sensor, an ambient temperature sensor, and/or an acoustic sensor (e.g., a microphone, a phased-array of microphones, and/or the like).

In some non-limiting embodiments, the object detection sensors may enable system architecture 200 to detect objects that are within a given distance range of the vehicle in any direction, and environmental sensor 268 may collect data about environmental conditions within an area of operation and/or travel of the vehicle.

During operation of system architecture 200, information is communicated from the sensors of system architecture 200 to vehicle on-board computing device 220. Vehicle on-board computing device 220 analyzes the data captured by the sensors and optionally controls operations of the vehicle based on results of the analysis. For example, vehicle on-board computing device 220 may control: braking via brake controller 222; direction via steering controller 224; speed and acceleration via throttle controller 226 (e.g., in a gas-powered vehicle) or motor speed controller 228, such as a current level controller (e.g., in an electric vehicle); differential gear controller 230 (e.g., in vehicles with transmissions); and/or other controllers, such as auxiliary device controller 254.

Geographic location information may be communicated from location sensor 260 to vehicle on-board computing device 220, which may access a map of the environment, including map data that corresponds to the location information to determine known fixed features of the environment, such as streets, buildings, stop signs, and/or stop/go signals. Captured images from cameras 262 and/or object detection information captured from sensors, such as LiDAR sensor system 264, is communicated from those sensors to vehicle on-board computing device 220. The object detection information and/or captured images are processed by vehicle on-board computing device 220 to detect objects in proximity to the vehicle. Any known or to be known technique for making an object detection based on sensor data and/or captured images can be used in the embodiments disclosed in the present disclosure.

In some non-limiting embodiments, automotive Ethernet adaptor device 102 may be connected to one or more components of system architecture 200, such as engine or motor 202, sensors 204-218, sensors 236-240, location sensor 260, environmental sensor 268, clock 242, camera 262, LiDAR sensor system 264, and/or radar and/or sonar system 266, controllers 222-230, and/or auxiliary device controller 254. In some non-limiting embodiments, automotive Ethernet adaptor device 102 may be capable of translating data received from the one or more components of system architecture 200 (e.g., into a USB data format) to be provided to USB device 106. In some non-limiting embodiments, automotive Ethernet adaptor device 102 may be capable of translating data received from USB device 106 (e.g., into an automotive Ethernet format, an Ethernet standard associated with automotive Ethernet, such as a 100BASE-T1 Ethernet standard, etc.) and providing the data (e.g., the translated data) to the one or more components of system architecture 200.

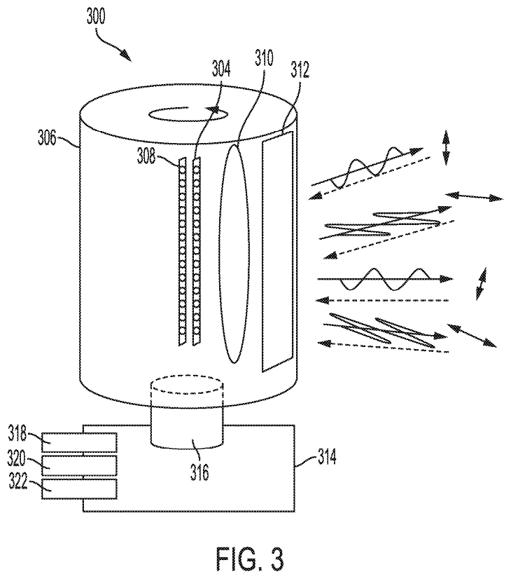

Referring now to FIG. 3, FIG. 3 is an illustration of a non-limiting embodiment of LiDAR sensor system 300. LiDAR sensor system 264 of FIG. 2 may be the same as or substantially similar to LiDAR sensor system 300. As shown in FIG. 3, LiDAR sensor system 300 may include housing 306, which may be rotatable 360° about a central axis, such as a hub or axle of motor 316. Housing 306 may include an emitter/receiver aperture 312 made of a material transparent to light (e.g., transparent to infrared light). Although a single aperture is shown in FIG. 3, non-limiting embodiments of the present disclosure are not limited in this regard. In some non-limiting embodiments, multiple apertures for emitting and/or receiving light may be provided. In this way, LiDAR sensor system 300 can emit light through one or more of aperture(s) 312 and receive reflected light back toward one or more of aperture(s) 312 as housing 306 rotates around the internal components. In an alternative scenario, the outer shell of housing 306 may be a stationary dome, at least partially made of a material that is transparent to light, with rotatable components inside of housing 306.

Inside the rotating shell or stationary dome is light emitter system 304 that is configured and positioned to generate and emit pulses of light through aperture 312 or through the transparent dome of housing 306 via one or more laser emitter chips or other light emitting devices. Light emitter system 304 may include any number of individual emitters (e.g., 8 emitters, 64 emitters, 128 emitters, etc.). The emitters may emit light of substantially the same intensity or of varying intensities. The individual beams emitted by light emitter system 304 may have a well-defined state of polarization that is not the same across the entire array. As an example, some beams may have vertical polarization and other beams may have horizontal polarization. LiDAR sensor system 300 may include light detector 308 containing a photodetector or array of photodetectors positioned and configured to receive light reflected back into the system. Light emitter system 304 and light detector 308 may rotate with the rotating shell, or light emitter system 304 and light detector 308 may rotate inside the stationary dome of housing 306. One or more optical element structures 310 may be positioned in front of light emitter system 304 and/or light detector 308 to serve as one or more lenses and/or waveplates that focus and direct light that is passed through optical element structure 310.

One or more optical element structures 310 may be positioned in front of a mirror to focus and direct light that is passed through optical element structure 310. As described herein below, LiDAR sensor system 300 may include optical element structure 310 positioned in front of a mirror and connected to the rotating elements of LiDAR sensor system 300, so that optical element structure 310 rotates with the mirror. Alternatively or in addition, optical element structure 310 may include multiple such structures (e.g., lenses, waveplates, etc.). In some non-limiting embodiments, multiple optical element structures 310 may be arranged in an array on or integral with the shell portion of housing 306.

In some non-limiting embodiments, each optical element structure 310 may include a beam splitter that separates light that the system receives from light that the system generates. The beam splitter may include, for example, a quarter-wave or half-wave waveplate to perform the separation and ensure that received light is directed to the receiver unit rather than to the emitter system (which could occur without such a waveplate as the emitted light and received light should exhibit the same or similar polarizations). In some non-limiting embodiments, each optical element structure 310 may include a polarized beam splitter that may be used to separate light, where the light is circularly polarized. In some non-limiting embodiments, the beam that is transmitted and the beam that is received may have opposite polarizations.

LiDAR sensor system 300 may include power unit 318 to power light emitter system 304, motor 316, and electronic components. LiDAR sensor system 300 may include analyzer 314 with elements, such as processor 322 and non-transitory computer-readable memory 320 containing programming instructions that are configured to enable the system to receive data collected by the light detector unit, analyze the data to measure characteristics of the light received, and generate information that a connected system can use to make decisions about operating in an environment from which the data was collected. Analyzer 314 may be integral with LiDAR sensor system 300 as shown, or some or all of analyzer 314 may be external to LiDAR sensor system 300 and communicatively connected to LiDAR sensor system 300 via a wired and/or wireless communication network or link.

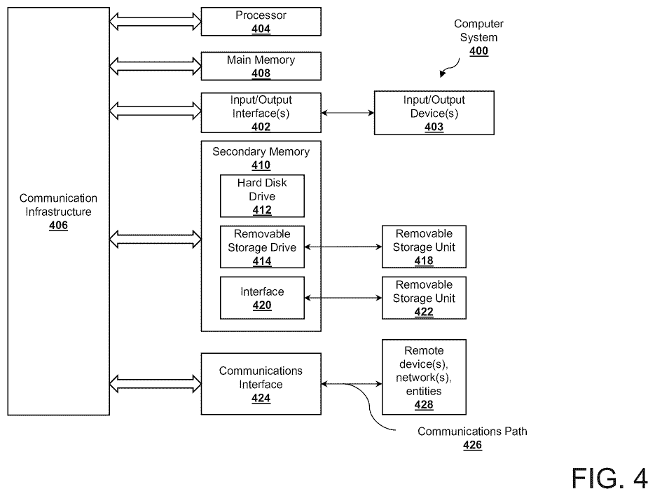

Referring now to FIG. 4, FIG. 4 is a diagram of an architecture for a computing system 400. Computing system 400 can correspond to automotive Ethernet adaptor device 102 (e.g., one or more components of automotive Ethernet adaptor device 102), autonomous vehicle 104 (e.g., one or more components of autonomous vehicle 104), and/or USB device 106. In some non-limiting embodiments, automotive Ethernet adaptor device 102 (e.g., one or more components of automotive Ethernet adaptor device 102), autonomous vehicle 104 (e.g., one or more components of autonomous vehicle 104), and/or USB device 106 can include at least one computing device 400 and/or at least one component of computing device 400.

In some non-limiting embodiments or aspects, computer system 400 may be any computer capable of performing the functions described herein. Computer system 400 may include one or more processors (also called central processing units, or CPUs), such as processor 404. In some non-limiting embodiments, a processor may include one or more hardware components that perform operations, such as logic operations. Processor 404 is connected to a communication infrastructure or bus 406. One or more processors 404 may each be a graphics processing unit (GPU). In some non-limiting embodiments or aspects, a GPU may include a processor that is a specialized electronic circuit designed to process mathematically intensive applications. The GPU may have a parallel structure that is efficient for parallel processing of large blocks of data, such as mathematically intensive data common to computer graphics applications, images, videos, etc. In some non-limiting embodiments or aspects, one or more processors 404 (e.g., CPU, GPU, and/or the like) may include, be part of, and/or be connected to one or more hardware accelerators. For example, a hardware accelerator may include an artificial intelligence (AI) accelerator.

In some non-limiting embodiments, computer system 400 also may include input/output device(s) 403 (e.g., user input/output device(s), such as monitors, keyboards, pointing devices, etc.), that communicate with communication infrastructure 406 through input/output interface(s) 402 (e.g., user input/output interface(s)). Computer system 400 also may include a main or primary memory 408, such as random access memory (RAM). Main memory 408 may include one or more levels of cache. Main memory 408 may have stored therein control logic (i.e., computer software) and/or data. Computer system 400 may also include one or more secondary storage devices or memory 410. Secondary memory 410 may include, for example, hard disk drive 412 and/or removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, removable solid state drive (SSD), removable hard disk drive, and/or any other computer data storage device. Removable storage drive 414 reads from and/or writes to removable storage unit 418 in any suitable manner.

In some non-limiting embodiments or aspects, secondary memory 410 may include other means, instrumentalities, or other approaches for allowing computer programs and/or other instructions and/or data to be accessed by computer system 400. Such means, instrumentalities, or other approaches may include, for example, removable storage unit 422 and interface 420. Examples of removable storage unit 422 and interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

In some non-limiting embodiments, computer system 400 may further include communications or network interface 424. Communications interface 424 may enable computer system 400 to communicate and interact with any combination of remote device(s), remote network(s), remote entities, etc. (individually and collectively referenced by reference number 428). For example, communications interface 424 may allow computer system 400 to communicate with remote device(s) 428 over communications path 426, which may be wired and/or wireless, and which may include any combination of LANs, WANs, the Internet, etc. Control logic and/or data may be transmitted to and from computer system 400 via communications path 426.

In some non-limiting embodiments or aspects, a tangible, non-transitory apparatus or article of manufacture comprising a tangible, non-transitory computer useable or readable medium having control logic (software) stored thereon also may be referred to herein as a computer program product or a program storage device. This may include, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

The number and arrangement of components shown in FIG. 4 are provided as an example. In some non-limiting embodiments or aspects, computer system 400 may include additional components, fewer components, different components, or differently arranged components than those shown in FIG. 4. Additionally, or alternatively, a set of components (e.g., one or more components) of computer system 400 may perform one or more functions described as being performed by another set of components of computer system 400.

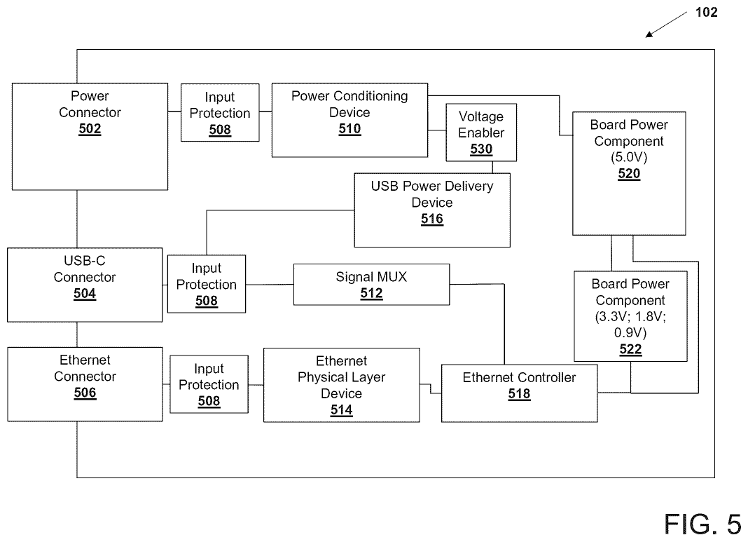

Referring now to FIG. 5, FIG. 5 is a diagram of automotive Ethernet adaptor device 102. As shown in FIG. 5, automotive Ethernet adaptor device 102 may include a plurality of external facing automotive grade connectors that are designed to meet automotive specifications for thermal, shock, and/or vibration conditions. For example, automotive Ethernet adaptor device 102 may include power connector 502, USB-C connector 504, and Ethernet connector 506. In some non-limiting embodiments, USB-C connector 504 may be replaced by another type of USB connector, such as a USB-A connector. In such an example, automotive Ethernet adaptor device 102 may have more or less components as described with regard to FIG. 5. For instance, automotive Ethernet adaptor device 102 may not include USB power delivery device 516.

In some non-limiting embodiments, power connector 502 may allow for a power source to be connected (e.g., permanently connected, temporarily connected, releasably connected, etc.) to automotive Ethernet adaptor device 102. In some non-limiting embodiments, USB-C connector 504 may allow for a USB compatible device (e.g., USB device 106) with a corresponding USB-C connecting component to be connected to automotive Ethernet adaptor device 102. USB-C connector 504 may provide for a data signal and/or a power signal to be provided to a USB compatible device connected at USB-C connector 504. In some non-limiting embodiments, Ethernet connector 506 may allow for an Ethernet compatible device with a corresponding Ethernet connecting component and/or an Ethernet cable to be connected to automotive Ethernet adaptor device 102. In some non-limiting embodiments, Ethernet connector 506 may include a base-T1 connector to provide a 100/1000 base-T1 connection.

In some non-limiting embodiments, each of power connector 502, USB-C connector 504, and Ethernet connector 506 may include input protection 508. For example, power connector 502, USB-C connector 504, and Ethernet connector 506 may include input protection 508 at a downstream side of power connector 502, USB-C connector 504, and Ethernet connector 506. In some non-limiting embodiments, input protection 508 may include overcurrent protection, such as a fuse, and/or electrostatic discharge protection, such as a transient-voltage-suppression (TVS) diode, on all pins and/or rails for a respective connector.

As further shown in FIG. 5, automotive Ethernet adaptor device 102 may include additional components, such as power conditioning device 510, USB power delivery device 516, signal multiplexer (MUX) 512, Ethernet physical layer device 514, Ethernet controller 518, board power component 520, and board power component 522.

In some non-limiting embodiments, power conditioning device 510 may include one or more devices that receive a power signal as an input via power connector 502 and deliver a level of voltage that has characteristics to enable load equipment to function properly by improving power quality (e.g. based on power factor correction, noise suppression, transient impulse protection, etc.) of the input power signal. For example, power conditioning device 510 may include a converter, such as a DC to DC converter and/or the like. In some non-limiting embodiments, power conditioning device 510 may regulate a main input power (e.g., a power signal received at power connector 502) to 5.0V and then further regulate the 5.0V power signal to 3.3V, 1.8V and/or 0.9V power signal.

In some non-limiting embodiments, signal MUX 512 may include one or more devices, such as a multiplexer (e.g., a multiplexor, a data selector, etc.), that selects between a plurality of input signals and provides the selected input signal to a single output line. Signal MUX 512 may receive a signal (e.g., power signal or data signal) and provide the signal to another component of automotive Ethernet adaptor device 102 as appropriate. As shown in FIG. 5, signal MUX 512 may provide a signal to USB power delivery device 516 and/or Ethernet controller 518.

In some non-limiting embodiments, Ethernet physical layer device 514 may include one or more devices, such as one or more transceivers, for transmitting and receiving data (e.g., data in a format of Ethernet frames) that specifies types of signals, signaling rates, media types, connector types, and/or network topologies for communication on an Ethernet network. In some non-limiting embodiments, Ethernet physical layer device 514 may include a physical layer device for automotive Ethernet, such as a 100BASE-T1 physical layer (PHY) device. In some non-limiting embodiments, Ethernet physical layer device 514 may provide a signal to Ethernet controller 518. In some non-limiting embodiments, Ethernet physical layer device 514 may be a component of Ethernet controller 518. In some non-limiting embodiments, Ethernet physical layer device 514 may receive a signal from Ethernet controller 518 and Ethernet controller 518 may allow for transmission of the signal along an Ethernet network (e.g., an automotive Ethernet network of autonomous vehicle 104) connected to automotive Ethernet adaptor device 102 via Ethernet connector 506.

In some non-limiting embodiments, USB power delivery device 516 may include one or more devices that enable a USB-C device (e.g., USB device 106), which is connected to automotive Ethernet adaptor device 102 via USB-C connector 504, to be charged (e.g., to receive a power signal via USB-C connector 504). In some non-limiting embodiments, USB power delivery device 516 may enable charging based on a USB standard, such as a USB PD standard and/or a USB-C standard. In some non-limiting embodiments, USB power delivery device 516 may include a controller (e.g., a microcontroller) that controls transmission of power signals on automotive Ethernet adaptor device 102. In some non-limiting embodiments, power conditioning device 510, voltage enabler 530, and/or USB power delivery device 516 may make up a power switching circuit of automotive Ethernet adaptor device 102. In some non-limiting embodiments, the controller of USB power delivery device 516 may control operation of the power switching circuit.

In some non-limiting embodiments, Ethernet controller 518 may include one or more devices that control Ethernet communications conducted on an Ethernet network (e.g., an automotive Ethernet network of autonomous vehicle 104) between devices connected to automotive Ethernet adaptor device 102. In some non-limiting embodiments, Ethernet controller 518 may include a USB-C to Ethernet Media Access Controller (MAC) that communicates with Ethernet physical layer device 514 through a Media-Independent interface (MII), such as a reduced gigabit MII, of Ethernet controller 518. In some non-limiting embodiments, Ethernet controller 518 may support communications according to a USB 3.1 generation 1 (Gen 1) standard.

In some non-limiting embodiments, board power component 520 and board power component 522 may each include one or more devices that are connected to other components of automotive Ethernet adaptor device 102. Board power component 520 may include one or more devices that operate at a higher voltage than board power component 522. For example, board power component 520 may include one or more devices that operate at 5.0V. In such an example, board power component 522 may include one or more devices that operate at 3.3 V, 1.8V, and/or 0.9V. In some non-limiting embodiments, board power component 520 may provide power to board power component 522. For example, board power component 520 may receive a power signal at a first voltage (e.g., 5.0V) from power conditioning device 510, and board power component 520 may convert the first voltage to a second voltage (e.g., 3.3V, 1.8V, 0.9V, etc.) to be used by board power component 522. In some non-limiting embodiments, board power component 520 and board power component 522 may include one or more components of system architecture 200, such as engine or motor 202, sensors 204-218, sensors 236-240, location sensor 260, environmental sensor 268, clock 242, camera 262, LiDAR sensor system 264, and/or radar and/or sonar system 266, controllers 222-230, and/or auxiliary device controller 254.

In some non-limiting embodiments, voltage enabler 530 may include one or more devices that provide for the ability to turn on or off an output voltage of a power supply connected at power connector 502 without having to interrupt the input voltage (e.g., an AC input voltage or a DC input voltage) with a relay and/or a switch. In some non-limiting embodiments, voltage enabler 530 may include a hotswap controller. In some non-limiting embodiments, voltage enabler 530 may be a component of USB power delivery device 516 or a component of power conditioning device 510.

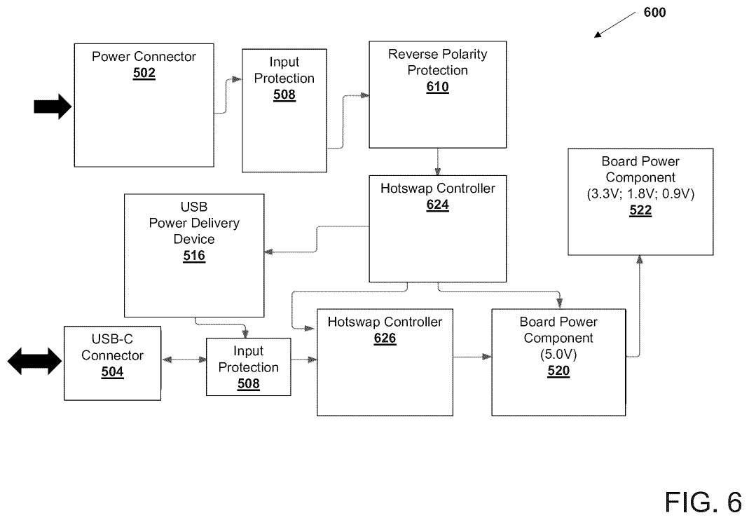

Referring now to FIG. 6, FIG. 6 is a diagram of a non-limiting embodiment of power delivery architecture 600 of automotive Ethernet adaptor device 102. As shown in FIG. 6, power delivery architecture 600 may include power connector 502, USB-C connector 504, input protection 508, USB power delivery device 516, board power component 520, board power component 522, reverse polarity protection 610, hotswap controller 624, and hotswap controller 626.

In some non-limiting embodiments, reverse polarity protection 610 may include one or more devices that prevent electrical current from flowing towards power connector 502, such as when a voltage downstream of reverse polarity protection 610 becomes higher than a voltage at power connector 502. In some non-limiting embodiments, reverse polarity protection 610 may include one or more diodes. In some non-limiting embodiments, reverse polarity protection 610 may be a component of power conditioning device 510.

In some non-limiting embodiments, hotswap controller 624 and hotswap controller 626 may each include one or more devices that are capable of monitoring voltage conditions (e.g., overvoltage and/or undervoltage conditions) and/or causing switches to open and/or close. In some non-limiting embodiments, hotswap controller 624 may provide a signal (e.g., a signal that indicates a state of a power source connected at power connector 502, such as whether a main power source is connected at power connector 502, whether a power signal provided by a main power source connected at power connector 502 is sufficient to provide power to other components of automotive Ethernet adaptor device 102, etc.) to USB power delivery device 516. In some non-limiting embodiments, USB power delivery device 516 may control the transmission of power signals on automotive Ethernet adaptor device 102 based on the signal received from hotswap controller 624. For example, USB power delivery device 516 may prevent or allow a power signal to be provided at USB-C connector 504 based on the signal received from hotswap controller 624. Additionally or alternatively, USB power delivery device 516 may prevent or allow a power signal to be provided to board power component 520 and/or board power component 522 based on the signal received from hotswap controller 624. In some non-limiting embodiments, hotswap controller 624 may provide the signal to hotswap controller 626 and/or board power component 520. In some non-limiting embodiments, hotswap controller 626 may provide a signal to board power component 520 and board power component 520 may operate accordingly. In some non-limiting embodiments, board power component 520 may provide a signal to board power component 522 and board power component 522 may operate accordingly.

As shown in FIG. 6, power is configured to flow in one direction regarding power connector 502. For example, a power signal may flow into (e.g., be received at) power connector 502 based on a power source connected at power connector 502, but a power signal may not flow out of (e.g., be provided at) power connector 502 to a power source connected at power connector 502. As further shown in FIG. 6, power is configured to flow in two directions regarding USB-C connector 504. For example, a power signal may flow into (e.g., be received at) USB-C connector 504 based on a USB-C device (e.g., USB device 106) connected at USB-C connector 504 and a power signal may flow out of (e.g., be provided at) USB-C connector 504 to a power source connected at power connector 502.

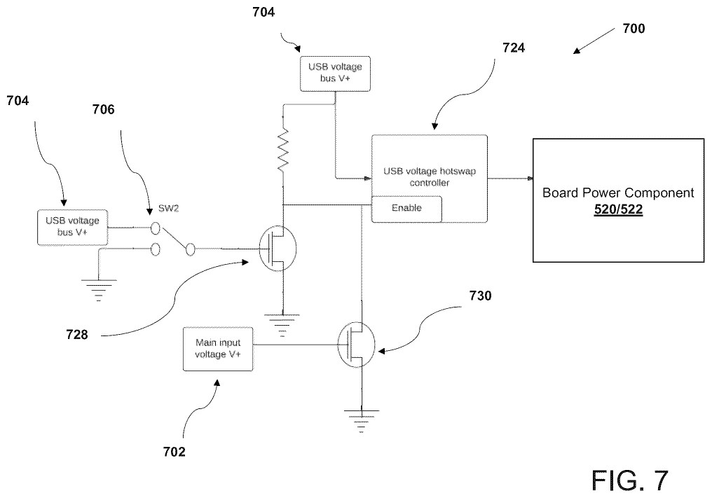

Referring now to FIG. 7, FIG. 7 is a diagram of a non-limiting embodiment of power switching circuit 700 of automotive Ethernet adaptor device 102. As shown in FIG. 7, power switching circuit 700 may include switch 706, transistor 728, transistor 730, and USB voltage hotswap controller 724. In some non-limiting embodiments, USB voltage hotswap controller 724 may be the same as hotswap controller 624 or hotswap controller 626. As further shown in FIG. 7, power switching circuit 700 may be connected to voltage node 704 from USB voltage bus V+ that is available based on USB-C connector 504 and voltage node 702 from main input voltage V+ that is available based on power connector 502.

In some non-limiting embodiments, when a power signal is available at voltage node 702, a power source is connected to power connector 502 and the power source is in an ON-state. When the power source is in the ON-state, a power signal is available at power connector 502, voltage node 702 will provide a power signal to transistor 730, and transistor 730 may provide an indication to USB voltage hotswap controller 724 that a power signal is available and USB voltage hotswap controller 724 may allow power to be provided to board power component 520 and/or board power component 522. In addition, when switch 706 is in a first position to connect voltage node 704 to transistor 728, a USB-C device connected to USB-C connector 504 may receive the power signal. When the power source is in an OFF-state and there is not a USB-C device connected to USB-C connector 504, automotive Ethernet adaptor device 102 may be in an OFF-state.

In some non-limiting embodiments, switch 706 may be used to determine whether a USB-C device connected via USB-C connector 504 may receive power or provide power to automotive Ethernet adaptor device 102. When switch 706 is in a first state, switch 706 is in a position to connect a ground to transistor 728, power switching circuit 700 is configured to prevent power from being received from a USB-C device connected via USB-C connector 504. In such a case, USB voltage hotswap controller 724 may not receive an indication from transistor 728 that provides for enabling USB voltage hotswap controller 724. When switch 706 is in a second state, when switch 706 is in a position to connect voltage node 704 to transistor 728, power switching circuit 700 is configured to allow power to be received from a USB-C device connected via USB-C connector 504. In such a case, USB voltage hotswap controller 724 may receive an indication from transistor 728 that provides for enabling USB voltage hotswap controller 724. In either the first state or the second state of switch 706, a power source connected at power connector 502 may be in the OFF-state (e.g., automotive Ethernet adaptor device 102 may be in an OFF-state based on the OFF-state of the power source). In some non-limiting embodiments, switch 706 may be controlled by USB power delivery device 516 (e.g., a controller of USB power delivery device 516).

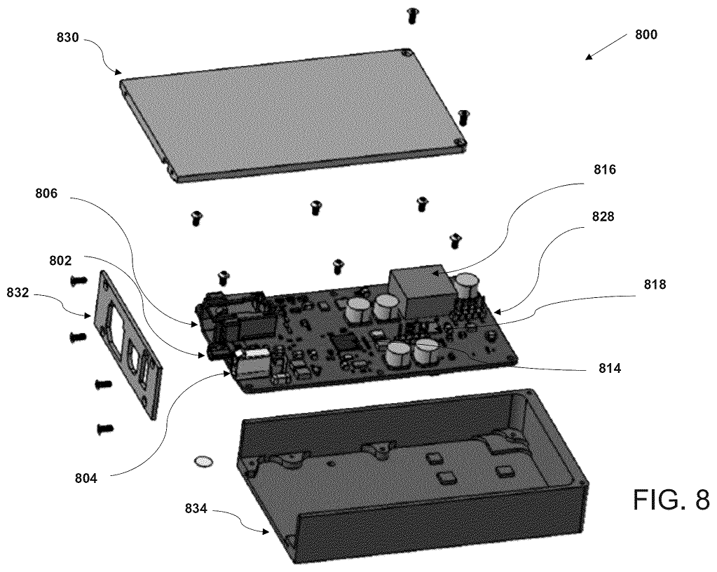

Referring now to FIG. 8, FIG. 8 is a perspective view of a non-limiting embodiment of automotive Ethernet adaptor device 800. In some non-limiting embodiments, automotive Ethernet adaptor device 800 and all similarly named components thereof (e.g., power connector 802, USB-C connector 804, Ethernet connector 806, Ethernet physical layer device 814, Ethernet controller 818, etc.) may be the same as or similar to automotive Ethernet adaptor device 102 and all similarly named components thereof (e.g., power connector 502, USB-C connector 504, Ethernet connector 506, Ethernet physical layer device 514, Ethernet controller 518, etc.). In some non-limiting embodiments, automotive Ethernet adaptor device 800 may include a housing for a printed circuit board (PCB) that includes a plurality of components of automotive Ethernet adaptor device 800. As shown in FIG. 8, automotive Ethernet adaptor device 800 may include power connector 802, USB-C connector 804, Ethernet connector 806, Ethernet physical layer device 814, Ethernet controller 818, and power switching circuit 816 may be positioned on (e.g., attached to) PCB 828. As shown in FIG. 8, a housing, which may include top housing portion 830, front housing portion 832, and base housing portion 834, may be sized and configured to enclose PCB 828 and the attached components. As further shown in FIG. 8, front housing portion 832 may include a plurality of apertures so that access may be provided to power connector 802, USB-C connector 804, and Ethernet connector 806.

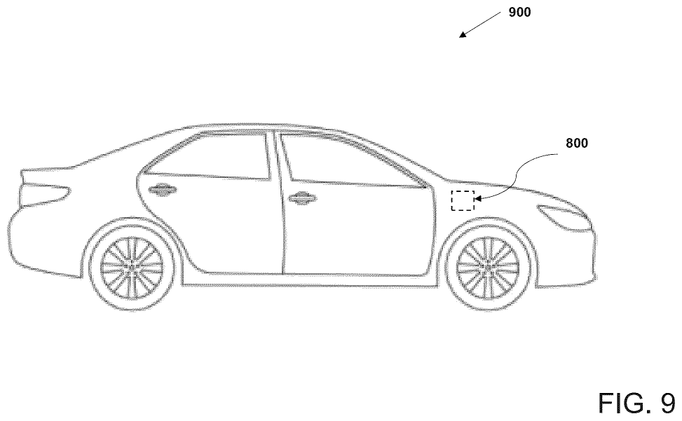

Referring now to FIG. 9, FIG. 9 is a diagram of a non-limiting embodiment of autonomous vehicle 900 including automotive Ethernet adaptor device 800. In some non-limiting embodiments, autonomous vehicle 900 may be the same as or similar to autonomous vehicle 104. As shown in FIG. 9, automotive Ethernet adaptor device 800 may be positioned at a location towards a front end of autonomous vehicle 900. In some non-limiting embodiments, automotive Ethernet adaptor device 800 may be positioned at a location appropriate for automotive Ethernet adaptor device 800 to be connected to an automotive Ethernet network of autonomous vehicle 900.

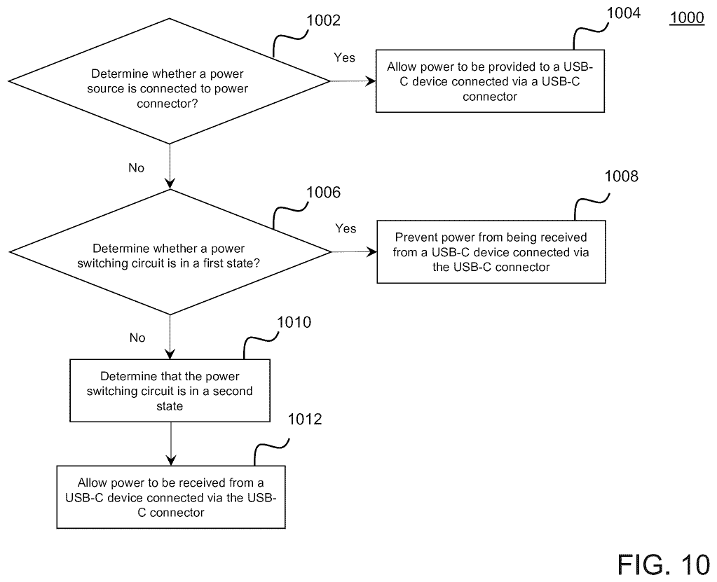

Referring now to FIG. 10, FIG. 10 is a flowchart of a non-limiting embodiment of process 1000 for operating an automotive Ethernet adaptor device for use with automotive Ethernet. In some non-limiting embodiments, one or more of the steps of process 1000 may be performed (e.g., completely, partially, etc.) by automotive Ethernet adaptor device 102 (e.g., one or more components of automotive Ethernet adaptor device 102, such as a controller of USB power delivery device 516, etc.). In some non-limiting embodiments, one or more of the steps of process 1000 may be performed (e.g., completely, partially, etc.) by another device or a group of devices separate from or including automotive Ethernet adaptor device 102, such as autonomous vehicle 104 (e.g., system architecture 200, etc.) and/or USB device 106.

As shown in FIG. 10, at step 1002, process 1000 includes determining whether a power source is connected to power connector. For example, a controller of automotive Ethernet adaptor device 102 may determine whether a power source (e.g., a power supply, such as an AC power supply, a DC power supply, etc.) is connected to power connector 502. In some non-limiting embodiments, the controller of automotive Ethernet adaptor device 102 may determine whether a power source is connected to power connector 502 based on a signal provided by a hotswap controller. For example, the controller of automotive Ethernet adaptor device 102 may determine whether a power source is connected to power connector 502 based on a signal provided by a hotswap controller that provides an indication of whether a power source is connected.

As shown in FIG. 10, at step 1004 (“Yes”), process 1000 includes allowing power to be provided to a USB-C device connected via a USB-C connector. For example, the controller of automotive Ethernet adaptor device 102 may allow power to be provided to USB device 106, when USB-C device is connected to automotive Ethernet adaptor device 102 via USB-C connector 504. In some non-limiting embodiments, the controller of automotive Ethernet adaptor device 102 may allow power to be provided to USB device 106 based on determining that a power source is connected to power connector 502.

As shown in FIG. 10, at step 1006 (“No”), process 1000 includes determining whether a power switching circuit is in a first state. For example, the controller of automotive Ethernet adaptor device 102 may determine whether a power switching circuit (e.g., power switching circuit 700) is in a first state. In some non-limiting embodiments, the controller of automotive Ethernet adaptor device 102 may determine whether the power switching circuit is in the first state based on determining that a power source is not connected to power connector 502.

As shown in FIG. 10, at step 1008 (“Yes”), process 1000 includes preventing power from being received from a USB-C device connected via the USB-C connector. For example, the controller of automotive Ethernet adaptor device 102 may prevent power from being received from USB device 106 that is connected to automotive Ethernet adaptor device 102 via USB-C connector 504. In some non-limiting embodiments, the controller of automotive Ethernet adaptor device 102 may prevent power from being received from USB-C device based on determining that the power switching circuit is not in the first state.

As shown in FIG. 10, at step 1010 (“No”), process 1000 includes determining that the power switching circuit is in a second state. For example, the controller of automotive Ethernet adaptor device 102 may determine that the power switching circuit is in a second state based on determining that the power switching circuit is not in the first state.

As shown in FIG. 10, at step 1012, process 1000 includes allowing power to be received from a USB-C device connected via the USB-C connector. For example, the controller of automotive Ethernet adaptor device 102 may allow power to be received from USB device 106 connected to automotive Ethernet adaptor device 102 via USB-C connector 504. In some non-limiting embodiments, when the power switching circuit is in the second state, automotive Ethernet adaptor device 102 may receive power at the USB-C connector and/or provide a power signal to a board power component (e.g., board power component 520 and/or board power component 522)

In some non-limiting embodiments, the controller of automotive Ethernet adaptor device 102 may convert, via an Ethernet controller (e.g., Ethernet controller 518), a first signal received via the USB-C connector to a second signal that is formatted for automotive Ethernet. In some non-limiting embodiments, the first signal is a signal formatted according to a USB 3.0 standard and the second signal is a signal formatted according to a 100BASE-T1 Ethernet standard. In some non-limiting embodiments, the second signal is a signal formatted for LAN Ethernet. In some non-limiting embodiments, the controller of automotive Ethernet adaptor device 102 may convert the signal formatted according to a USB 3.0 standard and received via the USB-C connector, to the signal that is formatted according to the 100BASE-T1 Ethernet standard.

In some non-limiting embodiments, the controller of automotive Ethernet adaptor device 102 may receive, via an Ethernet physical layer device (e.g., Ethernet physical layer device 514), the second signal from the Ethernet controller, convert the second signal to a third signal that is formatted for automotive Ethernet, and provide, via the Ethernet physical layer device, the third signal to a device connected at an Ethernet connector. In some non-limiting embodiments, the controller of automotive Ethernet adaptor device 102 may provide power, via a USB PD device (e.g., USB power delivery device 516), at a USB-C connector (e.g., USB-C connector 504). In some non-limiting embodiments, the controller of automotive Ethernet adaptor device 102 may provide a control signal, via a hotswap controller (e.g., hotswap controller 624 or hotswap controller 626), to the power switching circuit to cause the power switching circuit to change from the first state to the second state.

Although embodiments have been described in detail for the purpose of illustration and description, it is to be understood that such detail is solely for that purpose and that embodiments are not limited to the disclosed embodiments, but, on the contrary, are intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. An adapter device for use with automotive Ethernet, the adapter device comprising:
a power connector;
a universal serial bus type-c (USB-C) connector; and
a power switching circuit;
wherein, when the power switching circuit is in a first state, the power switching circuit is configured to prevent power from being received from a USB-C device connected via the USB-C connector; and
wherein, when the power switching circuit is in a second state, the power switching circuit is configured to allow power to be received from a USB-C device connected via the USB-C connector.

2. The adapter device of claim 1, wherein, when a power source is connected to the power connector, the power switching circuit is configured to allow power to be provided to a USB-C device connected via the USB-C connector.

3. The adapter device of claim 1, further comprising:
a printed circuit board (PCB);
wherein the power connector, the USB-C connector, and the power switching circuit are attached to the PCB.

4. The adapter device of claim 1, wherein the power switching circuit comprises:
a USB Power Delivery (PD) device that is configured to provide power at the USB-C connector.

5. The adapter device of claim 1, further comprising:
a DC-DC convertor connected to the power connector, wherein the DC-DC convertor is configured to provide a power signal to the power switching circuit.

6. The adapter device of claim 1, further comprising:
an Ethernet controller; and
a printed circuit board (PCB);
wherein the power connector, the USB-C connector, the power switching circuit, and the Ethernet controller are attached to the PCB; and
wherein the Ethernet controller is configured to convert a first signal received from a USB-C device via the USB-C connector to a second signal that is formatted for automotive Ethernet.

7. The adapter device of claim 6, further comprising:
an Ethernet connector;
wherein the power connector, the USB-C connector, the power switching circuit, the Ethernet controller, and the Ethernet connector are attached to the PCB.

8. An adapter device for use with automotive Ethernet, the adapter device comprising:
a power connector;
a universal serial bus type-c (USB-C) connector;
an Ethernet controller; and
a power switching circuit;
wherein, when the power switching circuit is in a first state, the power switching circuit is configured to prevent power from being received from a USB-C device connected via the USB-C connector;
wherein, when the power switching circuit is in a second state, the power switching circuit is configured to allow power to be received from a USB-C device connected via the USB-C connector; and
wherein the Ethernet controller is configured to convert a first signal received via the USB-C connector to a second signal that is formatted for automotive Ethernet.

9. The adapter device of claim 8, wherein the first signal is a signal formatted according to a USB 3.0 standard, wherein the second signal is a signal formatted according to a 100BASE-T1 Ethernet standard, and wherein the Ethernet controller is configured to convert the signal formatted according to a USB 3.0 standard received via the USB-C connector to the signal that is formatted according to the 100BASE-T1 Ethernet standard.

10. The adapter device of claim 8, further comprising:
an Ethernet connector; and
an Ethernet physical layer device;
wherein the Ethernet physical layer device is configured to receive the second signal from the Ethernet controller and convert the second signal to a third signal that is formatted for automotive Ethernet; and
wherein the Ethernet physical layer device is configured to provide the third signal to a device connected at the Ethernet connector.

11. The adapter device of claim 10, wherein the Ethernet physical layer device is configured to convert the second signal to the 100BASE-T1 Ethernet standard.

12. The adapter device of claim 10, further comprising:
a DC-DC convertor connected to the power connector, wherein the DC-DC convertor is configured to provide a power signal to the power switching circuit.

13. The adapter device of claim 10, wherein the power switching circuit comprises:
a USB Power Delivery (PD) device that is configured to provide power at the USB-C connector.

14. The adapter device of claim 10, further comprising:
a hotswap controller device;
wherein the hotswap controller device is configured to provide a control signal to the power switching circuit to cause the power switching circuit to change to the second state.

15. A method of operating an adapter device for use with automotive Ethernet, the method comprising:
determining, with at least one processor, whether a power source is connected to a power connector of an adapter device;
determining, with at least one processor, whether a power switching circuit is in a first state based on determining that a power source is not connected to the power connector of the adapter device, wherein, when the power switching circuit is in the first state, the power switching circuit is configured to prevent power from being received from a universal serial bus type-c (USB-C) device connected via a USB-C connector of the adapter device;
determining, with at least one processor, whether the power switching circuit is in a second state based on determining that the power switching circuit is not in the second state, wherein, when the power switching circuit is in the second state, the power switching circuit is configured to allow power to be received from a USB-C device connected via the USB-C connector; and
allowing, with at least one processor, power to be received from a USB-C device connected via the USB-C connector based on determining that the power switching circuit is in the second state.

16. The method of claim 15, further comprising:
converting, via an Ethernet controller, a first signal received via the USB-C connector to a second signal that is formatted for automotive Ethernet, wherein the first signal is a signal formatted according to a USB 3.0 standard, and wherein the second signal is a signal formatted according to a 100BASE-T1 Ethernet standard.

17. The method of claim 15, further comprising, when the power switching circuit is in the second state:
receiving power at the USB-C connector; and
providing a power signal to a board power component.

18. The method of claim 16, further comprising:
receiving, via an Ethernet physical layer device, the second signal from the Ethernet controller;
converting the second signal to a third signal that is formatted for automotive Ethernet; and
providing, via the Ethernet physical layer device, the third signal to a device connected at an Ethernet connector.

19. The method of claim 15, further comprising:
providing a control signal, via a hotswap controller, to the power switching circuit to cause the power switching circuit to change from the first state to the second state.

20. The method of claim 15, further comprising:
providing power, via a USB Power Delivery (PD) device, at the USB-C connector.
